(19) United States
(12) Patent Application Publication
(10) Pub. No.: US 2024/0343865 A1
(43) Pub. Date: Oct. 17, 2024

(54) Polyimide Resin, Resin Composition Comprising Polyimide Resin and Cured Product Thereof

(71) Applicant: Nippon Kayaku Kabushiki Kaisha, Tokyo (JP)

(72) Inventors: Kengo Nishimura, Tokyo (JP); Chie Sasaki, Tokyo (JP); Ryutaro Tanaka, Tokyo (JP); Noriyuki Nagashima, Tokyo (JP)

(21) Appl. No.: 18/294,340

(22) PCT Filed: Jun. 1, 2022
(86) PCT No.: PCT/JP2022/022278

§ 371 Date: Feb. 1, 2024

(30) Foreign Application Priority Data
Aug. 3, 2021 (JP) 2021-127039

(51) Int. Cl. C08G 73/10; C08F 220/36; C08L 79/08

(52) U.S. Cl. CPC C08G 73/1042; C08F 220/36; C08G 73/1021; C08G 73/1082; C08L 79/08; C08L 2201/08; C08L 2203/20

(57) ABSTRACT

A polymide resin is the product of a reaction between an imidized compound (P) of a polyamic acid resin with a compound (C) having a functional group, that can react with a phenolic hydroxyl group, and an ethylenically unsaturated double bond group. The polyamic acid resin is a copolymer of amino compounds (A) and a tetrabasic acid dianhydride (B). Amino compounds (A) contain an aminophenol compound (a1) having at least two amino groups per molecule, an aliphatic diamino compound (a2) having 6-36 carbon atoms, and an aromatic diamino compound (a3) having no phenolic hydroxyl group.

### CROSS REFERENCE TO RELATED APPLICATIONS

This application is the United States national phase of International Patent Application No. PCT/JP2022/022278 filed Jun. 1, 2022, and claims priority to Japanese Patent Application No. 2021-127039 filed Aug. 3, 2021, the disclosures of which are hereby incorporated by reference in their entireties.

### BACKGROUND OF THE INVENTION

### Field of the Invention

The present invention relates to a polyimide resin having a novel structure, a resin composition containing the polyimide resin and cured products of the resin composition.

### Description of Related Art

As an essential member for the mobile communication devices such as smartphone (mobile phone) and tablet computer, the communication base station apparatus and the electronics such as computer and car navigation device, a printed wiring board is used. Various resin materials excellent in the characteristics such as metal foil adhesion, heat resistance and flexibility are used for the printed wiring board.

Recently, the printed wiring board for the high-speed and large-capacity next-generation high frequency radio communication device has been developed. The resin material having low transmission loss, namely low dielectric constant and low dielectric loss tangent in addition to the characteristics described above is required.

The polyimide resin excellent in the characteristics such as heat resistance, flame resistance, flexibility, electric property and chemical resistance is widely used for an electric-electronic parts, a semiconductor, a communication device and a circuit part thereof, a peripheral device and the like. The hydrocarbon compounds derived from petroleum and natural oil are known to exhibit high insulating property and low dielectric constant. In view of the characteristics of the both compounds, the polyimide resin having a structure into which a dimer diamine having a long chain alkylene skeleton is introduced is described in Patent Document 1. The polyimide resin described in Patent Document 1 is excellent because it has a low dielectric loss tangent but inferior in base material adhesion and mechanical property.

It is described that the polyimide resin using the diamine having a phenolic hydroxy group as a raw material is excellent in adhesion and mechanical property in Patent Document 2. However, the polyimide resin has low solder heat resistance. The polyimide resin has low lamination property because the resin has high viscosity due to the hydrogen bond between phenolic hydroxy groups. The polyimide resin has high water absorption and the dielectric property of the resin becomes worse after moisture absorption.

### CITATION LIST

### Patent Document

Patent Document 1: JP 2018-168369 A
Patent Document 2: Japanese patent application No. 2020-535005

### SUMMARY OF INVENTION

### Technical Problem

One of the purposes of the present invention is to provide a resin material which has a novel structure and can be suitably used for a printed wiring board, a resin composition containing the resin material and the cured products of which has excellent base material adhesion, mechanical properties, heat resistance, lamination properties, and dielectric properties after moisture absorption.

### Solution to Problem

By the earnest research, the present inventors found to solve the problems by using a resin composition containing a novel polyimide resin having the specific structure so as to finish the present invention.

That is, the present invention relates to:
[1] A polyimide resin that is a reaction product of an imidized compound (P) of a polyamic acid resin, the polyamic acid resin being a copolymer of amino compounds (A) containing an aminophenol compound (a1) having at least two amino groups per a molecule, an aliphatic diamino compound (a2) having 6-36 carbon atoms and an aromatic diamino compound (a3) having no phenolic hydroxy group and a tetrabasic acid dianhydride (B), with a compound (C) having a functional group that can react with a phenolic hydroxy group and an ethylenically unsaturated double bond group.
[2] The polyimide resin according to [1], wherein the aminophenol compound (a1) comprises a compound represented by a following formula (1):

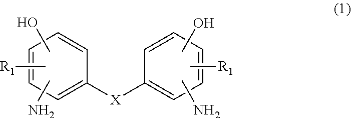

wherein in formula (1), R₁ is a hydrogen atom, a methyl group or an ethyl group, X is C(CH₃)₂, C(CF₃)₂, SO₂, an oxygen atom, a direct bond or a bivalent linking group represented by a following formula (2):

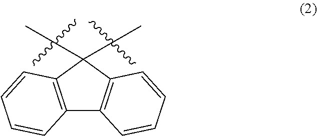 [SMILES: *C1(*)c2ccccc2-c2ccccc21]

[3] The polyimide resin according to [1], wherein the tetrabasic acid dianhydride (B) comprises at least one selected from a group consisting of compounds represented by following formulas (3) to (7):

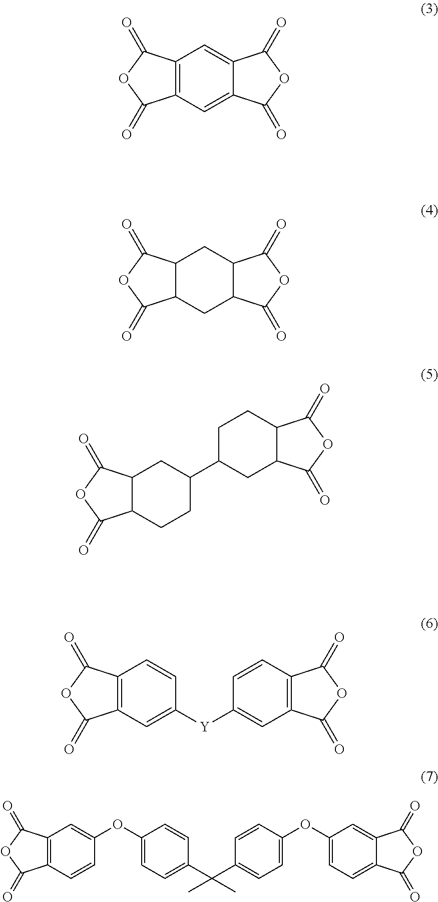

wherein in formula (6), Y is C(CF₃)₂, SO₂, CO, an oxygen atom, a direct bond or a bivalent linking group represented by following formula (2):

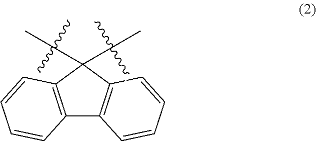 [SMILES: *C1(*)c2ccccc2-c2ccccc21]

[4] The polyimide resin according to [1], wherein the functional group that can react with the phenolic hydroxy group of the compound (C) is an isocyanate group or a carboxylic acid chloride group.
[5] The polyimide resin according to [1], wherein the aromatic diamino compound (a3) comprises at least one selected from a group consisting of compounds represented by following formulas (8) to (11):

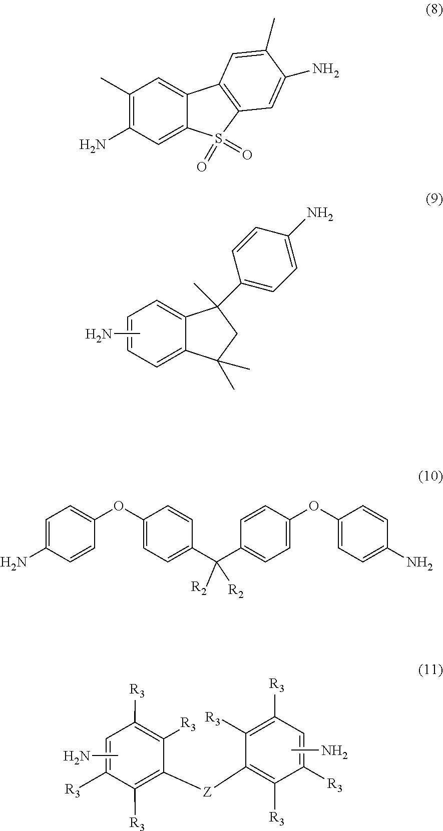

wherein in formula (10), R₂ is each independently methyl group or trifluoromethyl group, in formula (11), Z is CH(CH₃), SO₂, CH₂, O—C₆H₄—O, an oxygen atom, a direct bond or a bivalent linking group represented by a following formula (2):

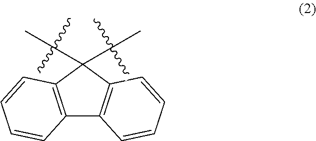 [SMILES: *C1(*)c2ccccc2-c2ccccc21]

[6] A resin composition comprising the polyimide resin according to any one of [1] to [5] and a thermosetting resin.
[7] The resin composition according to [6] further comprising a curing agent.
[8] The resin composition according to [6] further comprising a silane coupling agent having an acrylic group.
[9] A cured product of the resin composition according to [6].
[10] An article provided with the cured product according to [9].

### DESCRIPTION OF THE INVENTION

### Effects of the Invention

By using the polyimide resin of the present invention having a specific structure, the printed wiring board and the like excellent in the properties such as heat resistance, mechanical property, low dielectric property and adhesion can be provided.

### Form to Carry Out Invention

The polyimide resin of the present invention is a reaction product of an imidized compound (P) (hereinafter, simply described as “imidized compound (P)”) of a polyamic acid resin, said polyamic acid resin being a copolymer of amino compounds (A) (hereinafter, also simply described as “component (A)”) containing an aminophenol compound (a1) (hereinafter, also simply described as “component (a1)”) having at least two amino groups per a molecule, an aliphatic diamino compound (a2) (hereinafter, also simply described as “component (a2)”) having 6-36 carbon atoms and an aromatic diamino compound (a3) (hereinafter, also simply described as “component (a3)”) having no phenolic hydroxy group and a tetrabasic acid dianhydride (B) (hereinafter, also simply described as “component (B)”), with a compound (C) (hereinafter, also simply described as “component (C)”) having a functional group that can react with a phenolic hydroxy group and an ethylenically unsaturated double bond group.

First, the imidized compound (P) that is the intermediate raw material of the polyimide resin of the present invention is described.

[Aminophenol Compound (a1) (Component (a1))]

The component (a1) used for the synthesis of the imidized compound (P) is not particularly limited as long as the component (a1) is a compound having at least two amino groups and at least one phenolic hydroxy group per a molecule. Examples of the component (a1) include 3,3′-diamino-4,4′-dihydroxydiphenyl sulfone, 3,3′-diamino-4,4′-dihydroxydiphenyl ether,3,3′-diamino-4,4′-dihydroxybiphenyl,3,3′-diamino-4,4′-dihydroxybenzophenone,2,2-bis(3-amino-4-hydroxyphenyl)methane, 2,2-bis(3-amino-4-hydroxyphenyl)ethane,2,2-bis(3-amino-4-hydroxyphenyl)propane,1.3-hexafluoro-2,2-bis(3-amino-4-hydroxyphenyl)propane and 9,9′-bis(3-amino-4-hydroxyphenyl)fluorene. These may be used alone or in mixture of two or more.

The component (a1) used for the synthesis of the imidized compound (P) preferably comprises a compound represented by following formula (1).

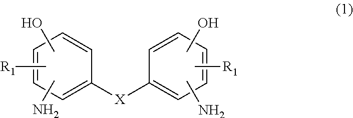

In formula (1) R₁ is a hydrogen atom, a methyl group or, an ethyl group, X is C(CH₃)₂, C(CF₃)₂, SO₂, an oxygen atom, a direct bond or a bivalent linking group represented by following formula (2):

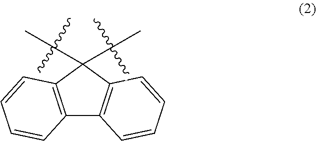 [SMILES: *C1(*)c2ccccc2-c2ccccc21]

In this specification, the direct bond indicates the condition that two benzene rings directly combine with each other not through a carbon atom or the other atom. Hereinafter, in the description about the sign Y and Z described below, the direct bond means the same matter.

The amount of the component (a1) when synthesizing the imidized compound (P) is preferably the amount satisfying the conditions that the phenolic hydroxy group equivalent of the imidized compound (P) is in the range from 1,500 to 25,000 g/eq. When the phenolic hydroxy group equivalent is less than 1,500 g/eq., the dielectric loss tangent of the cured product of the resin composition containing the polyimide resin may be high because the polarity of the polyimide resin of the present invention obtained in the end is high. When the phenolic hydroxy group equivalent is more than 25,000 g/eq., due to the decrease of the points of reaction with the component (C) described below the cross-linking points of the polyimide resin obtained in the end are decreased and thus heat resistance and adhesion to the base material of the cured products of the resin composition are apt to decline.

Note that the phenolic hydroxy group equivalent in this specification is a value measured according to JIS K-0070.

The imidized compound (P) is obtained by the imidization reaction, namely the cyclization reaction due to dehydration condensation, of the polyamic acid resin being the copolymer of the component (A) and the component (B). The amounts (the rates) of the component (A) and the component (B) necessary to synthesize the imidized compound (P) having the purposed hydroxy group equivalent and the purposed amount of aliphatic chain is easily calculated from each molecular weight of the component (A) and the component (B) used for the copolymerization reaction and the number of the phenolic hydroxy group of the component (a1).

[Aliphatic Diamino Compound (a2) (Component (a2))]

The component (a2) used for the synthesis of the imidized compound (P) is not particularly limited as long as the component (a2) is an aliphatic compound having two amino groups per a molecule and a carbon number of 6 to 36. The component (a2) may have any aliphatic structure of the straight chain, the branched chain or the circle or the combined structure of the structures described above. The component (a2) may be either of the saturated aliphatic compound or the unsaturated aliphatic compound. Examples of the component (a2) include hexamethylenediamine, 1,3-bis(aminomethyl)cyclohexane, 1,3-bisaminomethylcyclohexane, norbornanediamine, isophoronediamine, dimer diamine, 2-methyl-1,5-diaminopentane, 1,7-diaminoheptane, 1,8-diaminooctane, 1,9-diaminononane, 1,10-diaminodecane, 1,11-diaminoundecane, 1,12-diaminododecane, 1,4-bis(aminomethyl)cyclohexane, 4,4′-methylenebiscyclohexylamine and diaminopolysiloxane having a carbon number of 6 to 36. These compounds may be used alone or in mixture of two or more. From the viewpoint of dielectric property of the polyimide resin, the dimer diamine is preferably used.

The dimer diamine described as an example of the component (a2) is a compound obtained by substituting the primary amino groups for two carboxy groups of the dimer acid which is the dimer of the unsaturated fatty acids such as oleic acid (see JP H₉-12712 A and the like). Examples of the commercial products of dimer diamine include PRIAMINE1074 and PRIAMINE1075 (both manufactured by Croda Japan K.K.) and Versamine551 (manufactured by Cognis Japan Ltd.). These may be used alone or in mixture of two or more. In the next section, the non-limiting general formulas of the dimer diamine are shown (In each formula m, n, p, q are the number of repetition and the real number. m+n=6 to 17 are preferable, p+q=8 to 19 are preferable, and the broken line means a carbon-carbon single bond or a carbon-carbon double bond.).

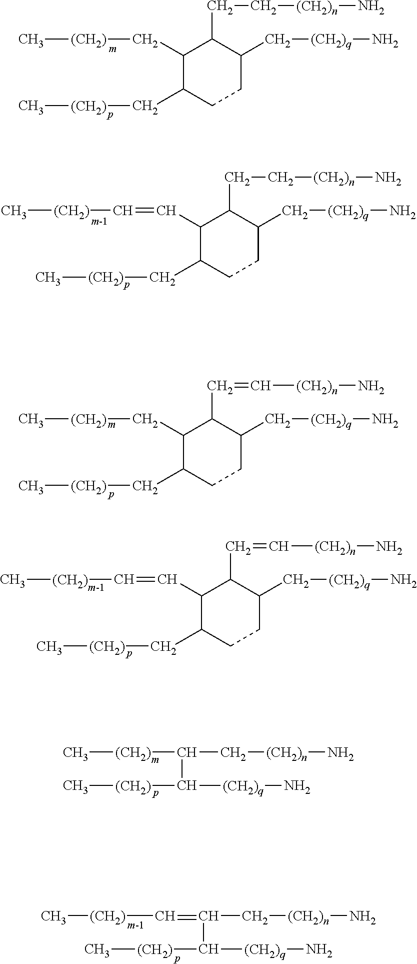

The amount of the component (a2) when synthesizing the imidized compound (P) is preferably within the range of 10 to 50 mass % of the mass (the mass of the imidized compound (P) generated) obtained by subtracting the mass of water, which is produced by dehydration condensation reaction and is equal to the double number of mol of the component (B), from the mass of the component (A). When the amount of the component (a2) is below the range aforementioned, the proportion of the aliphatic chain derived from the component (a2) in the polyimide resin obtained finally is too low, therefore, the dielectric loss tangent of the cured product of the resin composition may become high. When the amount of the component (a2) is above the range aforementioned, the proportion of the aliphatic chain derived from the component (a2) in the polyimide resin is too high, therefore, the heat resistance of the cured product of the resin composition may decrease.

[Aromatic Diamino Compound (a3) (Component (a3))]

The component (a3) used for synthesizing the imidized compound (P) is not particularly limited as long as the component (a3) is an aromatic diamino compound except the component (a1) aforementioned and an aromatic compound having two amino groups per a molecule. Examples of the compound (a3) includes m-phenylenediamine, p-phenylenediamine, m-tolylenediamine, 4,4′-diaminodiphenylether, 3,3′-dimethyl-4,4′-diaminodiphenylether, 3,4′-diaminodiphenylether, 4,4′-diaminodiphenylthioether, 3,3′-dimethyl-4,4′-diaminodiphenylthioether, 3,3′-diethoxy-4,4′-diaminodiphenylthioether,3,3′-diaminodiphenylthioether, 4,4′-diaminobenzophenone, 3,3′-dimethyl-4,4′diaminobenzophenone, 3,3′-diaminodiphenylmethane, 4,4′-diaminodiphenylmethane, 3.4′-diaminodiphenylmethane, 3,3′-dimethoxy-4,4′-diaminodiphenylthioether, 2,2′-bis(3-aminophenyl)propane, 2,2′-bis(4-aminophenyl)propane, 4,4′-diaminodiphenylsufoxide, 3,3′-diaminodiphenylsulfone, 4,4′-diaminodiphenylsulfone, benzidine, 3,3′-dimethylbenzidine, 3,3′-dimethoxybenzidine, 3,3′-diaminobiphenyl, p-xylylenediamine,m-xylylenediamine, o-xylylenediamine, 2,2′-bis(3-aminophenoxyphenyl)propane, 2,2′-bis(4-aminophenoxyphenyl)propane, 1,3-bis(4-aminophenoxyphenyl)benzene, 1,3′-bis(3-aminophenoxyphenyl)propane, bis(4-amino-3-methylphenyl)methane, bis(4-amino-3,5-dimethylphenyl)methane, bis(4-amino-3-ethylphenyl)methane, bis(4-amino-3,5-diethylphenyl)methane, bis(4-amino-3-propylphenyl)methane and bis(4-amino-3,5-dipropylphenyl)methane. These may be used alone or in mixture of two or more.

From the viewpoint of the heat resistance of the cured product of the resin composition and the solubility of the polyimide resin obtained in the end in the solvent, the component (a3) used for the synthesis of the imidized compound (P) preferably comprises at least one selected from the group consisting of the compounds represented by following formulas (8) to (11):

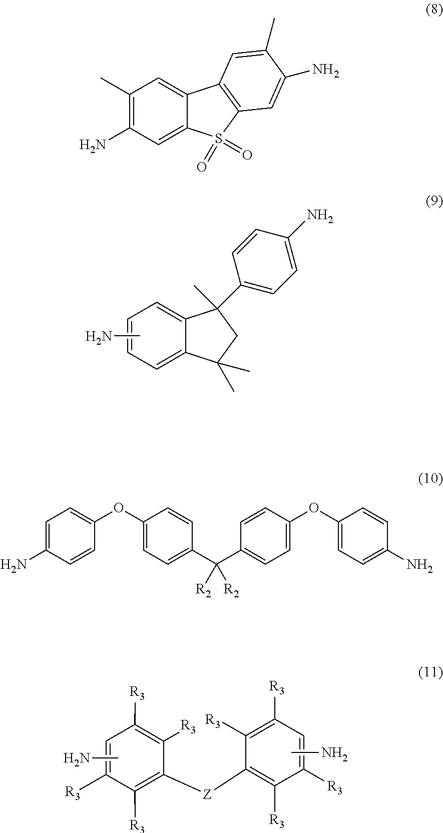

wherein in formula (10), R₂ is each independently methyl group or trifluoromethyl group; in formula (11), R₃ is each independently a hydrogen atom, methyl group or ethyl group, Z is CH(CH₃), SO₂, CH₂, O—C₆H₄—O, an oxygen atom, a direct bond or a bivalent linking group represented by formula (2) described above.

As described above, the amino compound (A) consists of at least the aminophenol compound (a1), the aliphatic diamino compound (a2) and the aromatic diamino compound (a3). As long as the purpose of the present invention is achieved, other amino compounds except the aminophenol compound (a1), the aliphatic diamino compound (a2) and the aromatic compound (a3) may be further used as the amino compound (A). However, other amino compounds except the aminophenol compound (a1), the aliphatic diamino compound (a2) and the aromatic compound (a3) are not preferably used.

### [Tetrabasic Acid Dianhydride (B) (Component (B))]

The component (B) used for synthesizing the imidized compound (P) is not particularly limited as long as the component (B) is a compound having two acid anhydride groups per a molecule. Examples of the component (B) include pyromellitic dianhydride, ethyleneglycol-bis(anhydrotrimellitate), glycerin-bis(anhydrotrimellitate)monoacetate, 1,2,3,4-butanetetracarboxylic acid dianhydride, 3,3′, 4,4′-diphenylsulfonetetracarboxylic acid dianhydride, 3,3′, 4,4′-benzophenonetetracarboxylic acid dianhydride, 3,3′, 4,4′-biphenyltetracarboxylic acid dianhydride, 3,3′, 4,4′-diphenylethertetracarboxylic acid dianhydride, 5-(2,5-dioxotetrahydro-3-furanyl)-3-methylcyclohexene-1,2-dicarboxylic acid anhydride, 3a,4,5,9b-tetrahydro-5-(tetrahydro-2,5-dioxo-3-furanyl)-naphtho[1,2-c]furan-1,3-dione, 1,2,4,5-cyclohexanetetracarboxylic acid dianhydride, bicyclo(2,2,2)-octo-7-ene-2,3,5,6-tetracarboxylic acid dihydride and bicyclo[2,2,2]octane-2,3,5,6-tetracarboxylic acid dihydride and 5,5′-((propane-2,2-diylbis(4,1-phenylene))bis(oxy))bis(isobenzofuran-1,3-dione). Among them in terms of solubility in solvent, adhesion to the base material and photosensitivity, 3,3′, 4,4′-diphenylsulfonetetracarboxylic acid dianhydride, 3,3′, 4,4′-benzophenonetetracarboxylic acid dianhydride, 3,3′, 4,4′-biphenyltetracarboxylic acid dianhydride or 3,3′, 4,4′-diphenylethertetracarboxylic acid dianhydride are preferable. These may be used alone or in mixture of two or more.

From the viewpoint of the solubility of the polyamic acid resin, the imidized compound (P) and the polyimide resin finally obtained in the solvent, the component (B) used for synthesizing the imidized compound (P) preferably includes at least one compound selected from the group consisting of the compounds represented by following formulas (3) and (7).

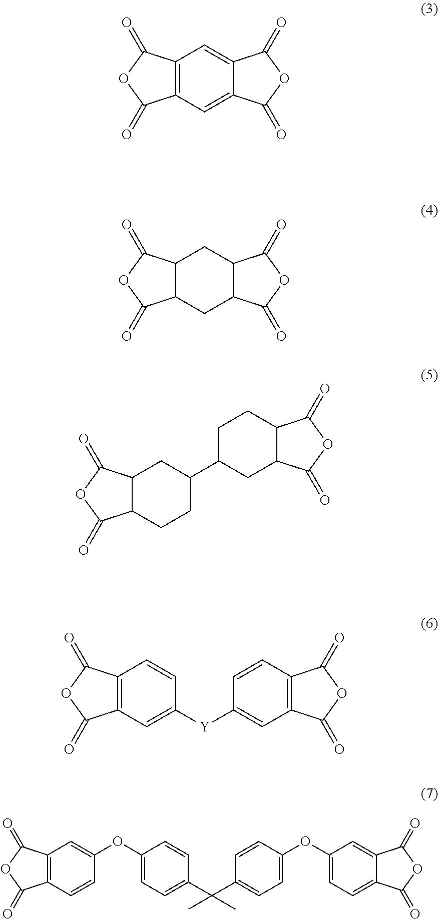

In formula (6), Y is C(CF₃)₂, SO₂, CO, an oxygen atom, a direct bond or a bivalent linking group represented by the formula (2) described above.

When a1M, a2M and a3M are the mol number of the component (a1), the component (a2) and the component (a3) in the component (A) used for the synthesis of the imidized compound (P) respectively, the value of a1M/(a1M+a2M+a3M) is preferably more than 0.01 and less than 0.3, more preferably more than 0.03 and less than 0.15. When the value of a1M/(a1M+a2M+a3M) is not more than 0.01, the sites to be reacted with the component (C) described below decrease and thus the base material adhesion and the solder heat resistance of the cured products of the resin composition are apt to decline. When the value of a1M/(a1M+a2M+a3M) is not less than 0.3, the dielectric property of the cured product of the resin composition is apt to decline.

The value of a2M/(a1M+a2M+a3M) is preferably more than 0.2 and less than 0.9, more preferably more than 0.3 and less than 0.6. When the value of a2M/(a1M+a2M+a3M) is not more than 0.2, the dielectric property of the cured product of the resin composition is apt to become worse and the solubility of the polyimide resin in the solvent is apt to become worse. When the value of a2M/(a1M+a2M+a3M) is not less than 0.9, heat resistance of the cured products of the resin composition is apt to become worse.

The value of a3M/(a1M+a2M+a3M) is preferably more than 0.1 and less than 0.8 more preferably more than 0.2 and less than 0.6. When the value of a3M/(a1M+a2M+a3M) is not more than 0.1, the solder heat resistance of the cured product of the resin composition is apt to become worse. When the value of a3M/(a1M+a2M+a3M) is not less than 0.8, the solubility of the polyimide resin in the solvent is apt to become worse.

MA and MB are the mol numbers of the components (A) and (B) respectively. By copolymerizing the components (A) and (B) so that MA and MB can satisfy the relationship MA/MB>1.0, the imidized compound (P) of the polyamic acid resin having amino groups at both ends is obtained. In this case, the value of MA/MB is preferably in the range of more than 1.0 and less than 2.0, more preferably in the range of more than 1.0 and less than 1.5. When the value is 2.0 or more, the polymerization of the polyimide resin finally obtained can be insufficient, besides various characteristics such as heat resistance of the resin composition (described below) after curing can deteriorate because of the high remaining rate of the unreacted raw materials.

MA and MB are the mol number of the components (A) and (B) respectively. By copolymerizing the components (A) and (B) so that MA and MB can satisfy the relationship MB/MA>1.0, the imidized compound (P) of the polyamic acid resin having carboxylic acid anhydride groups at both ends is obtained. In this case, the value of MB/MA is preferably in the range of more than 1.0 and less than 2.0, more preferably in the range of more than 1.0 and less than 1.5. When the value is 2.0 or more, the polymerization of the polyimide resin finally obtained can be insufficient, besides various characteristics such as heat resistance of the resin composition (described below) after curing can deteriorate because of the high remaining rate of the unreacted raw materials.

The imidized compound (P) can be synthesized by the known method.

For example, after the components (A) and (B) used for the synthesis are solved in the solvent, the copolymerization reaction of the diamine and tetrabasic acid dianhydride occur by stirring and heating at 10 to 140° C. under an inert gas atmosphere such as nitrogen to obtain the polyamic acid resin solution.

The imidization reaction (the ring closure reaction with dehydration) occur by stirring and heating at 100 to 300° C. after adding the dehydrating agent and the catalyst to the polyamic acid resin solution obtained above, if necessary, to obtain the imidized compound (P). Toluene and xylene can be used as the dehydrating agent and the tertiary amine and dehydration catalyst can be used as a catalyst. The heterocyclic tertiary amine is the preferable tertiary amine and examples of the heterocyclic tertiary amine include pyridine, picoline, quinoline and isoquinoline. Examples of the dehydration catalyst include acetic anhydride, propionic anhydride, n-butyric anhydride, benzoic anhydride and trifluoroacetic anhydride. Note that when polyamic acid resin and polyimide resin are synthesized, the reaction time is largely affected by the reaction temperature. The reaction is preferably carried out until the viscosity rises to an equilibrium according to the proceeding of the reaction and the maximum molecular weight is obtained. The reaction time is generally several minutes to 20 hours.

In the examples, the imidized compound (P) is synthesized via the polyamic acid resin. But the copolymerization reaction and the imidization reaction may occur simultaneously by adding the dehydrating agent and the catalyst if necessary, stirring and heating at 100 to 300° C., after the components (A) and (B) used for the synthesis are solved in the solvent to obtain the imidized compound (P).

Examples of the solvent used for the synthesis of the imidized compound (P) include methylethylketone, methylpropylketone, methylisopropylketone, methylbutylketone, methylisobutylketone, methyln-hexylketone, diethylketone, diisopropylketone, diisobutylketone, cyclopentanone, cyclohexanone, methylcyclohexanone, acetylacetone, γ-butyrolactone, diacetonealcohol, cyclohexene-1-one, dipropylether, diisopropylether, dibutylether, tetrahydrofuran, tetrahydropyran, ethylisoamylether, ethyl-t-butylether, ethylbenzilether, cresylmethylehter, anisole, phenetole, methyl acetate, ethyl acetate, propyl acetate, isopropyl acetate, butyl acetate, isobutyl acetate, amyl acetate, isoamyl acetate, 2-ethylhexyl acetate, cyclohexyl acetate, methylcyclohexyl acetate, benzil acetate, acetoacetic methyl, acetoacetic ethyl, methyl propionate, ethyl propionate, butyl propionate, benzil propionate, methyl butyrate, ethyl butyrate, isopropyl butyrate, butyl butyrate, isoamyl butyrate, methyl lactate, ethyl lactate, butyl lactate, ethyl isovalerate, isoamyl isovalerate, diethyl oxalate, dibutyl oxalate, methyl benzoate, ethyl benzoate, propyl benzoate, methyl salicylate, N-methyl pyrrolidone, N,N-dimethyl formaide, N,N-dimethyl acetoamide and dimethyl sufoxide, but is not limited to these compounds. These compounds may be used alone or in mixture of two or more.

The preferable amount of the solvent should be adjusted according to the viscosity and the application of the resin obtained. The solid content is preferably 10 to 60% by mass, more preferably 20 to 50% by mass.

When synthesizing the imidized compound (P), the catalysts are preferably used to accelerate the dehydration reaction. The amount of the catalysts is preferably 1 to 30 mol % of mol of the water produced by the dehydration condensation reaction and equal to the double number of mol of the component (B), more preferably 5 to 15 mol %. Examples of the usable catalysts include the generally known basic catalysts such as triethylamine and pyridine. Because of having the low boiling point and hardly remaining behind, triethylamine is preferable.

Next, the polyimide resin of the present invention that is the reaction product of the imidized compound (P) with the compound (C) (component (C)) having a functional group that can react with a phenolic hydroxy group and an ethylenically unsaturated double bond group is described.

[Compound (C) Having Functional Group that can React with Phenolic Hydroxy Group and Ethylenically Unsaturated Double Bond Group (Component (C))]

The component (c) used for the reaction with the imidized compound (P) is not particularly limited as long as the component (C) is a compound having a functional group that can react with a phenolic hydroxy group and an ethylenically unsaturated double bond group. In the polyimide resin of the present invention that is the product of the reaction between the phenolic hydroxy group of the imidized compound (P) with the component (C), the ethylenically unsaturated double bond groups derived from the component (C) can react with each other or the thermosetting resin described below and thus the cured product of the resin composition is excellent in both heat resistance and adhesion. By reacting the phenolic hydroxy group of the imidized compound (P) with the component (C), the viscosity of the polyimide resin is decreased and the lamination property on the base material is apt to be improved.

Examples of the functional group that can react with a phenolic hydroxy group of the component (C) include an isocyanate group, a carboxylic acid chloride group, an acid anhydride group, an epoxy group, a silyl chloride group, a halogenated alkyl group, an ester group, a sulfonyl chloride group and a carboxy group. Because the residual impurities derived from the leaving group are not produced from the component (C), the isocyanate group is particularly preferable.

Note that the ethylenically unsaturated double bond group of the component (C) is not particularly limited as long as the ethylenically unsaturated double bond group is c=c bond.

MA and MB are the mol number of the components (A) and (B) respectively. Because the end of the imidized compound (P) obtained by copolymerizing the components (A) and (B) so that MA and MB can satisfy the relationship MA/MB>0.1 is amine, the functional group of the component (C) that can react with a phenolic hydroxy group can react with the terminal amine of the imidized compound (P), when the functional group is an isocyanate group, a carboxylic acid chloride group, an acid anhydride group, an epoxy group, a silyl chloride group, a halogenated alkyl group, an ester group, a sulfonyl chloride group and a carboxy group.

Because the end of the imidized compound (P) obtained by copolymerizing the components (A) and (B) so that MA and MB can satisfy the relationship MA/MB<1.0 is acid anhydride, the functional group of the component (C) that can react with a phenolic hydroxy group can react with the terminal acid anhydride group of the imidized compound (P), when the functional group is an isocyanate group, an epoxy group, and a carboxy group.

Examples of the component (C) include Karenz MOI (manufactured by Showa Denko K.K.), Karenz AOI, Karenz MOI-BM, Karenz MOI-BP, Karenz BEI, Karenz MOI-EG, Karenz AOI-VM, methacrylic acid chloride, acrylic acid chloride, maleimide caproic acid chloride, allyl bromide, allyl iodide, allyl chloride, 4-chloro-1-butene, 4-bromo-1-butene, crotonoyl chloride and cinnamoyl chloride.

The polyimide resin of the present invention that is the reaction product of the imidized compound (P) with the component (C) can be synthesized by the known method. For example, the resin solution of the imidized compound (P) and the prescribed component (C) are mixed and reacted at a temperature from 80 to 150° C. to synthesize the polyimide resin.

Various catalysts may be used to proceed the reaction between the imidized compound (P) with the component (C). Known inorganic acid, organic acid, inorganic base and organic base can be used as the catalyst.

When MC is the mole number of the component (C) used for the synthesis of the polyimide resin of the present invention, MAB is the mol number of the phenolic hydroxy group of the imidized compound (P) and MP is the mol number of the terminal functional group of the imidized compound (P), the value of MC/(MAB+MP) is preferably more than 0.3 and less than 1.0, more preferably more than 0.5 and less than 1.0. when the value of MC/(MAB+MP) is not less than 1.0, heat resistance of the cured product of the resin composition become worse due to the unreacted component (C). When the value of MC/(MAB+MP) is not more than 0.3, the viscosity of the polyimide resin solution is increased due to the hydrogen bond of the phenolic hydroxy group unreacted with the component (C), the lamination property is apt to be decreased and moreover the base material adhesion of the cured product of the resin composition is apt to be decreased.

Next, the resin composition of the present invention is described.

The resin composition of the present invention can contain the polyimide resin that is the reaction product of the imidized compound (P) with the component (C), the thermosetting resin (compound) and the curing agent.

Examples of the thermosetting resin (compound) of the resin composition of the present invention include an epoxy resin, a maleimide resin, a carbodiimide resin, benzoxazine compound and the compound having an ethylenically unsaturated group. These resins and compounds can be used alone or in mixture of two or more according to the properties and the application of the cured product obtained.

By using the thermosetting resin together (compound) with the polyimide resin for the resin composition of the present invention, heat stability and high adhesion are imparted to the cured product of the resin composition.

Because the cured product of the resin composition is particularly excellent in heat resistance and adhesion, the maleimide resin or the compound having an ethylenically unsaturated group are preferably used as the thermosetting resin (compound) of the resin composition of the present invention.

Note that when MA is the mole number of the component (A), MB is the mole number of the component (B), MC is the mole number of the component (C), MAB is the mole number of the phenolic hydroxy group of the imidized compound (P) and MP is the mole number of the terminal functional group of the imidized compound (P), as a thermosetting resin, the epoxy resin is also preferably used together with the polyimide resin having the value of MA/MB of more than 1.0 and the value of MC/(MAB+MP) of more than 0 and less than 1.0.

Because the viscosity rise of the varnish which is the resin composition of the present invention containing the organic solvent can be restrained, the thermosetting resin (compound) preferably has a molecular weight of 100 to 50,000. Note that the molecular weight in this specification means the mass average molecular weight in terms of polystyrene by the gel permeation chromatography.

The maleimide resin used as a thermosetting resin is not particularly limited as long as the maleimide resin has two or more maleimide groups per a molecule. Because the cured product of the resin composition is excellent in the characteristics such as mechanical strength and fire retardance, the maleimide resin having an aromatic ring such as a benzene ring, a biphenyl ring and a naphthalene ring is preferable. Examples of the maleimide resin include MIR-3000 (manufactured by Nippon Kayaku Co., Ltd.), MIR-5000 (manufactured by Nippon Kayaku Co., Ltd.).

The maleimide resin is added to react with the ethylenically unsaturated double bond group of the polyimide resin of the present invention. By adding the maleimide resin, the crosslinking density of the cured product increases, the resistance to the polar solvent improves, and the adhesion to the base material and the heat resistance improves.

The curing temperature of the resin composition containing the maleimide resin is preferably 150 to 250° C. The curing time depends on the curing temperature and is generally about several minutes to several hours.

The content of the maleimide resin in the resin composition of the present invention containing the maleimide resin is preferably a content satisfying that the maleimide group equivalent of the maleimide resin is 0.1 to 500 equivalents to 1 equivalent of the ethylenically unsaturated double bond group of the polyimide resin.

To accelerate the curing reaction of the maleimide resin, as a curing agent, various the radical initiator can be added to the resin composition of the present invention containing the maleimide resin, if necessary. Examples of the radical initiator include peroxides such as dicumylperoxide and dibutylperoxide, azo compounds such as 2,2′-azobis(isobutyronitrile) and 2,2′-azobis(2,4-dimethyl valeronitrile). The content of the radical initiator in the resin composition of the present invention containing the maleimide resin is 0.1 to 10% by mass to the maleimide resin.

The epoxy resin used as a thermosetting resin is not particularly limited as long as the epoxy resin has two or more epoxy groups per a molecule. Because the cured product of the resin composition are excellent in the characteristics such as mechanical strength and fire retardance, the epoxy resin having an aromatic ring such as a benzene ring, a biphenyl ring and a naphthalene ring is preferable. Examples of the epoxy resin include jER828 (manufactured by Mitsubishi Chemical Corporation), NC-3000 and XD-1000 (both manufactured by Nippon Kayaku Co., Ltd.).

The epoxy resin is added to react with the phenolic hydroxy group or the terminal amino group or the acid anhydride group of the polyimide resin. By adding the epoxy resin, the crosslinking density of the cured product increases, the resistance to the polar solvent improves, and the adhesion to the base material and the heat resistance improves.

The curing temperature of the resin composition containing the epoxy resin is preferably 150 to 250° C. The curing time depends on the curing temperature and is generally about several minutes to several hours.

The content of the epoxy resin in the resin composition of the present invention containing the epoxy resin is preferably a content satisfying that the epoxy group equivalent of the epoxy resin is 0.1 to 500 equivalents to 1 equivalent of the phenolic hydroxy group, the active hydrogen of the terminal amino groups and the acid anhydride of the polyimide resin. Note that because the epoxy group contained in the epoxy resin has the reactivity to the phenolic hydroxy group, the epoxy resin having a content satisfying that the epoxy equivalent of the epoxy resin is 0.1 to 500 equivalents to 1 equivalent of the phenolic hydroxy group of the polyimide resin is the preferably added, if necessary.

To accelerate the curing reaction of the epoxy resin, the various the curing agent can be added to the resin composition of the present invention containing the epoxy resin, if necessary. Examples of the curing agent include imidazoles such as 2-methylimidazol, 2-ethylimidazole, 2-ethyl-4-methylimidazole, 2-phenyl-4,5-dihydroxymethylimidazole, and 2-phenyl-4-methyl-5-hydroxymethylimidazole, tertiary amines such as 2-(dimethylaminomethyl)phenol, and 1,8-diaza-bicyclo (5,4,0) undecene-7, phosphines such as triphenylphosphine, metal compounds such as tin octylate.

The content of the curing agent in the resin composition of the present invention containing the epoxy resin is 0.1 to 10% by mass to the epoxy resin.

The compound having an ethylenically unsaturated group used as a thermosetting resin is not particularly limited as long as the compound has an ethylenically unsaturated group in one molecule.

Examples of the compound having an ethylenically unsaturated group include methyl(meth)acrylate, ethyl(meth)acrylate,butyl(meth)acrylate, laulyl(meth)acrylate, polyethyleneglycol(meth)acrylate, polyethyleneglycol (meth)acrylate monomethyleter, phenylethyl(meth)acrylate, isobornyl(meth)acrylate, cyclohexyl(meth)acrylate, benzil(meth)acrylate, tetrahydrofurfuryl(meth)acrylate, butanedioldi(meth)acrylate, hexanedioldi(meth)acrylate, neopentylglycoldi(meth)acrylate, nonanedioldi(meth)acrylate, glycoldi(meth)acrylate, diethylenedi(meth)acrylate, polyethyleneglycoldi(meth)acrylate, tris(meth)acryloyloxyethylisocyanurate, polypropyleneglycoldi(meth)acrylate, adipic acid epoxydi(meth)acrylate, bisphenolethyleneoxidedi(meth)acrylate, hydrogenated bisphenolethyleneoxide(meth)acrylate, bisphenoledi(meth)acrylate, ε-caprolactone-modified hydroxy pivalic acidneopentylglycoldi(meth)acrylate, ε-caprolactone-modified dipentaerythritolhexa(meth)acrylate, ε-caprolactone-modified dipentaerythritolpoly(meth)acrylate, dipentaerythritolpoly(meth)acrylate, trimethylolpropanetri(meth)acrylate, triethylolpropanetri(meth)acrylate, and ethyleneoxide adduct thereof; pentaerythrioltri(meth)acrylate, and ethyleneoxide adduct thereof; dipentaerythritolhexa(meth)acrylate, and ethyleneoxide adduct thereof.

Besides, examples of the compound having an ethylenically unsaturated group include urethane(meth)acrylate having (meth)acryloyl groups and urethane bonds in the same molecule; polyester(meth)acrylate having (meth)acryloyl groups and ester bonds in the same molecule; epoxy(meth)acrylate derived from the epoxy resin and having (meth)acryloyl groups together; and the reactive oligomer having these bonds compositely.

Examples of the urethane(meth)acrylates include the reaction product of (meth)acrylate having hydroxy groups with polyisocyanate, if necessary, other alcohol. Examples of the urethane(meth)acrylate include hydroxyalkyl(meth)acrylates such as hydroxyethyl(meth)acrylate, hydroxypropyl(meth)acrylate, hydroxybutyl(meth)acrylate; glycerin(meth)acrylates such as glycerinmono(meth)acrylate, glycerindi(meth)acrylate; sugar-alcohol(meth)acrylates such as pentaerythritoldi(meth)acrylate, pentaerythritoltri(meth)acrylate, dipentaerythritolpenta(meth)acrylate, dipentaerythritolhexa(meth)acrylate; toluenediisocyanate, hexamethylenediisocyanate, trimethylhexamethylenediisocyanate, isophoronediisocyanate, norbornenediisocyanate, xylenediisocyanate, hydrogenated xylenediisocyanate, dicyclohexanemethylenediisocyanate, isocyanurate thereof and urethane(meth)acrylates obtained by reaction of the polyisocyanate such as the biuret compound.

Examples of polyester(meth)acrylates include monofunctional(poly)ester(meth)acrylates such as caprolactone-modified 2-hydroxyethyl(meth)acrylate, ethyleneoxide and/or propyleneoxide-modified phtalic acid(meth)acrylate, ethyleneoxide-modified succinic acid(meth)acrylate, caprolactone-modified tetrahydrofurfuryl(meth)acrylate;
di(poly)ester(meth)acrylates such as
hydroxypivalic acid esterneopentylglycoldi(meth)acrylate,caprolactone-modified hydroxypivalic acid esterneopentylglycoldi(meth)acrylate, epichlorohydrine-modified phtalic acid di(meth)acrylate; mono, di or tri(meth)acrylate of triol obtained by adding 1 mol or more of cyclic lactone compounds such as ε-caprolactone, γ-butyrolactone and δ-valerolactone to 1 mol of trimethylolpropane or glycerin.

Examples of polyester(meth)acrylates include mono, di, tri or tetra(meth)acrylate of triol obtained by adding 1 mol or more of cyclic lactone compounds such as ε-caprolactone, γ-butyrolactone and δ-valerolactone to 1 mol of pentaerythritol, dimethylolpropane, trimethylolpropane or tetramethylolpropane;
mono(meth)acrylate or poly(meth)acrylate of polyhydric alcohols such as triol, tetraol, pentaol or hexaol of mono or poly(meth)acrylate of triol obtained by adding 1 mol or more of cyclic lactone compounds such as ε-caprolactone, γ-butyrolactone and δ-valerolactone to 1 mol of dipentaerythritol.

Examples of polyester(meth)acrylates include polyfunctional(poly)ester(meth)acrylates such as (meth)acrylate of polyesterpolyol that is the reaction product of diol components such as (poly)ethyleneglycol, (poly)propyleneglycol, (poly)tetramethyleneglycol, (poly)butyleneglycol, 3-methyl-1.5-pentanediol and hexanediol with polybasic acids such as maleic acid, fumaric acid, succinic acid, adipic acid, phtalic acid, isophtalic acid, hexahydrophtalic acid,tetrahydrophtalic acid, dimer acid, sebacic acid, azelaic acid and 5-sodium sulfoisophtalic acid and anhydride thereof; and (meth)acrylate of cyclic lactone-modified polyesterdiol including the diol component, the polybasic acid and the anhydride thereof, ε-caprolactone, γ-butyrolactone and δ-valerolactone and the like.

Epoxy(meth)acrylates are the carboxylate compound obtained by the reaction between the compound having an epoxy group with (meth)acrylic acid, and the examples thereof include phenolnovolak-type epoxy(meth)acrylate, cresolnovolak-type epoxy(meth)acrylate, trishydroxyphenylmethane-type epoxy(meth)acrylate, dicycropentadienephenol-type epoxy(meth)acrylate, bisphenolA-type epoxy(meth)acrylate, bisphenolF-type epoxy(meth)acrylate, biphenol-type epoxy(meth)acrylate, bisphenolAnovolak-type epoxy(meth)acrylate, epoxy(meth)acrylate having the skeleton of naphthalene, glyoxal-type epoxy(meth)acrylate, heterocyclic epoxy(meth)acrylate and acid anhydride-modified epoxyacrylate thereof.

Examples of the compound having an ethylenically unsaturated group also include vinylethers such as ethylvinylether, propylvinylether, hydroxyethylvinylether, ethyleneglycoldivinylether; styrenes such as styrene, methylstyrene, ethylstyrene, divinylbenzene; the compounds having a vinyl group such as triallylisocyanurate, trimethallylisocyanurate and bisallylnadiimide.

The commercial products can be used as the compound having an ethylenically unsaturated group and examples theref include KAYARAD (the registered trademark) ZCA-601H (the trade name, manufactured by Nippon Kayaku Co., Ltd.) and propyleneglycolmonomethyletheracetate of TrisP-PA epoxyacrylate compound (manufactured by Nippon Kayaku Co., Ltd. KAYARAD (the registered trademark) ZCR-6007H (the trade name), KAYARAD (the registered trademark) ZCR-6001H (the trade name), KAYARAD (the registered trademark) ZCR-6002H (the trade name), KAYARAD (the registered trademark) ZCR-6006H (the trade name)). These compounds having an ethylenically unsaturated group can be used alone or in mixture of two or more according to circumstance.

The amount of the compound having an ethylenically unsaturated group in the resin composition of the present invention containing the compound having an ethylenically unsaturated group is preferably an amount satisfying that ethylenically unsaturated group equivalent to 1 equivalent of the ethylenically unsaturated double bond of the polyimide resin is 0.1 to 500 equivalents.

To accelerate the curing reaction between the polyimide resin with the ethylenically unsaturated group, a curing agent such as a radical initiator can be added to the resin composition of the present invention containing the compound having an ethylenically unsaturated group, if necessary. The examples of the radical initiator include peroxides such as dicumylperoxide and dibutylperoxide, azo compounds such as 2,2′-azobis(isobutyronitrile) and 2,2′-azobis(2,4-dimethyl valeronitrile).

The amount of the radical initiator in the resin composition of the present invention containing the compound having an ethylenically unsaturated group is 0.1 to 10% by mass to the ethylenically unsaturated group in all the resin composition.

The composition in varnish state (hereinafter described as varnish) may be obtained by using the organic solvent with the resin composition of the present invention. Examples of the solvent used include γ-butyrolactones, amide solvents such as N-methylpyrrolidone, N,N-dimethylformamide, N,N-dimethylacetoamide, and N,N-dimethylimidazolidinone, sulfones such as tetramethylenesulfone, ether solvent such as diethyleneglycoldimethylether, diethyleneglycoldiethylether, propyleneglycol, propyleneglycolmonomethylether, propyleneglycolmonomethylethermonoacetate, and propyleneglycolmonobutylether, ketone solvents such as methylethylketone, methyisobutylketone, cyclopentanone, and cyclohexanone, and aromatic solvents such as toluene and xylene.

The solvent is used in the range where the concentration of the solid content except the organic solvent in the varnish is preferably 10 to 80% by mass, more preferably 20 to 70% by mass.

The known additives may be used together with the resin composition of the present invention, if necessary. The examples of the additives used together include the epoxy resin curing agent, polybutadiene, or modified material thereof, modified material of acrylonitrile copolymer, polyphenylene ether, polystyrene, polyethylene, polyimide, fluororesin, maleimide compound, cyanateester compound, silicone gel, silicone oil, and inorganic filler such as silica, alumina, calcium carbonate, quartz powder, aluminium powder, graphite, talc, clay, iron oxide, titanium oxide, aluminium nitride, asbestos, mica, glass powder, surface treatment agent for the filler such as silane coupling agent, release agent, coloring agent such as carbon black, phtharocyanineblue, phtharocyanine green, thixotropy rendering agents such as aerosil, silicone and fluorine leveling agent and defoaming agent, phenol polymerization inhibitors such as hydroquinone and hydroquinonemonomethylether, stabilizer, antioxidant, photopolymerization initiator, photobase generator, and photoacid generator. The amount of the additives is preferably not more than 1,000 parts by mass, more preferably not more than 700 parts by mass, to 100 parts by mass of the resin composition.

From the viewpoint of heat resistance, the silane coupling agent having an acryl group or a methacryl group is particularly preferable additive.

The preparation method of the resin composition of the present invention is not particularly limited but may be simply mixing each component homogenously or producing the prepolymer. For example, by heating the polyimide resin or the terminal-modified polyimide resin of the present invention and the reactive compound in the presence or absence of the catalyst and in the presence or absence of the solvent, the prepolymer can be obtained. For mixing each component or producing the prepolymer, the extruder, the kneader, the roll and the like are used in the absence of the solvent and the reaction tank with stirrer and the like are used in the presence of the solvent.

The rein composition of the present invention can be made into the cured products by heating.

The curing temperature and the curing time of the resin composition may be selected in the consideration of the combination of the functional groups of the polyimide resin and the reactive groups of the thermosetting resin and the like. For example, the curing temperature of the resin composition having the maleimide resin and the resin composition having the epoxy resin is preferably 120 to 250° C. The curing time is generally about several tens of minutes to several hours.

The reinforced fiber such as glass fiber, carbon fiber, polyester fiber, polyamide fiber, alumina fiber is soaked with the resin composition of the present invention which is melted by heating to have low viscosity to obtain the prepreg. The reinforced fiber is also dried by heating after soaking with the vanish aforementioned to obtain the prepreg.

After the prepreg described above is cut to a desired shape and laminated with the copper foil and the like if necessary, while the laminated material is pressed by methods such as press forming method, autoclave forming method, or sheet-winding forming method, the resin composition is cured by heating to obtain the base material provided with the cured products (the articles) of the present invention such as the laminated board for the electric and electronic part (the printed wiring board) and the carbon-fiber-reinforced material.

After the copper foil is coated with the resin composition and the solvent is evaporated, the copper foil is laminated with a polyimide film or an LCP (liquid crystal polymer) and pressed while being heated. Then the laminated material is cured by heating to obtain the base material provided with the cured products of the present invention. In some cases, the polyimide film or the LCP is coated with the resin composition and laminated with the copper foil to obtain the base material having the cured product of the present invention.

Moreover, after the copper foil is coated with the resin composition of the present invention and the solvent is evaporated, the copper foil is laminated with the prepreg obtained by soaking the reinforced fiber such as glass fiber, carbon fiber, polyester fiber polyamide fiber alumina fiber with the resin and pressed while being heated. Then the laminated material is cured by heating to obtain the base material having the cured product of the present invention.

The base material having the polyimide resin (cured product) of the present invention described above can be used for the copper clad laminated sheet (CCL) or the printed wiring board and the multilayer wiring board having the circuit pattern on the copper foil of CCL.

### Examples

The present invention is now described in more detail with reference to Examples and Comparative Examples as follows and is not limit to these Examples. Note that in Examples the term “part” means “part by mass”, and the term “%” means “% by mass”. Note that the measurement condition of the GPC in Examples is as follows.
Machine: TOSOH ECOSEC Elite HLC-8420GPC
Column: TSKgel Super AWM-H
Eluent: NMP(N-methylpyrrolidone); 0.5 ml/min., 40° C.
Detector: UV (the differential refractometer)
Molecular weight standard: polystyrene

### Example 1 (Synthesis of Polyimide Resin 1 of Present Invention)

0.782 parts of DAPBAF (2,2-bis(3-amion-4-hydroxyphenyl)hexafluoropropane), manufactured by Wakayama Seika Kogyo Co., Ltd., molecular weight: 366.26 g/mol.), 11.784 parts of PRIAIMINE1075 (manufactured by Croda Japan KK, molecular weight: 534.38 g/mol.), 5.723 parts of BAFL (9,9-bis(4-aminophenyl)fluorene, manufactured by JFE Chemical Corporation, molecular weight: 348.16 g/mol), and 68.238 parts of anisole were added into a reactor with a total volume of 300 ml having a thermometer, a reflux cooler, a Dean-Stark apparatus, a powder inlet port, a nitrogen introduction device, and a stirrer and heated to 70° C. Next 12.409 parts of ODPA (oxydiphthalic anhydride, manufactured by Manac Incorporated, molecular weight: 310.22 g/mol.), 0.810 parts of triethylamine, and 14.987 parts of toluene were added. While the water generated by the cyclization of the amic acid was removed by azeotropy with toluene, the reaction was carried out at 130° C. for 8 hours to obtain the imidized compound (P-1) (phenolic OH equivalent, 6,780 g/eq., molecular weight: 78,600) solution. Then 0.663 parts of KarenzMOI (manufactured by Showa Denko K.K., molecular weight: 155.15 g/mol) and 0.088 parts of BHT (2,6-di-tert-butyl-p-cresol) as the polymerization inhibitor were added. After the reaction was carried out at 130° C. for 4 hours, the remaining triethylamine and toluene were continuously removed at 130° C. to obtain the polyimide resin 1 solution. The molar ratio of the diamine component (component (a1), component (a2) and component (a3)) to the acid anhydride component (component (B)) used in Example 1 was 1.01 (the molar ratio is “the number of mol of the diamine component/the number of mol of the acid anhydride component”). When MC was the mole number of the component (C) having the functional group that can react with the phenolic hydroxy group and the ethylenically unsaturated double bond group, MAB was the mol number of the phenolic hydroxy group of the imidized compound (P-1) and MP was the mol number of the terminal functional group of the imidized compound (P-1), the value of MC/(MAB+MP) was 0.85.

### Example 2 (Synthesis of Polyimide Resin 2 of Present Invention)

0.782 parts of DAPBAF (2,2-bis(3-amino-4-hydroxyphenyl)hexafluoropropane), manufactured by Wakayama Seika Kogyo Co., Ltd., molecular weight: 366.26 g/mol.), 11.784 parts of PRIAMINE1075 (manufactured by Croda Japan KK, molecular weight: 534.38 g/mol.), 5.723 parts of BAFL (9,9-bis(aminophenyl)fluorene, manufactured by JFE Chemical Corporation molecular weight: 348.16 g/mol), and 66.814 parts of anisole were added into a reactor with a total volume of 300 ml having a thermometer, a reflux cooler, a Dean-Stark apparatus, a powder inlet port, a nitrogen introduction device, and a stirrer and heated to 70° C. Next 11.768 parts of BPDA (3,3′,4,4′-biphenyltetracarboxylic acid dianhydride, manufactured by Mitsubishi Chemical Corporation, molecular weight: 294.22 g/mol.), 0.810 parts of triethylamine, and 14.884 parts of toluene were added. While the water generated by the cyclization of the amic acid was removed by azeotropy with toluene, the reaction was carried out at 130° C. for 8 hours to obtain the imidized compound (P-2) (phenolic OH equivalent, 6,701 g/eq., molecular weight: 117,000) solution. Then 0.663 parts of KarenzMOI (manufactured by Showa Denko K.K., molecular weight: 155.15 g/mol) and 0.086 parts of BHT (2,6-di-tert-butyl-p-cresol) as the polymerization inhibitor were added. After the reaction was carried out at 130° C. for 4 hours, the remaining triethylamine and toluene were continuously removed at 130° C. to obtain the polyimide resin 2 solution. The molar ratio of the diamine component (component (a1), component (a2) and component (a3)) to the acid anhydride component (component (B)) used in Example 2 was 1.01 (the molar ratio is “the number of mol of the diamine component/the number of mol of the acid anhydride component”). When MC was the mole number of the component (C) having the functional group that can react with the phenolic hydroxy group and the ethylenically unsaturated double bond group, MAB was the mol number of the phenolic hydroxy group of the imidized compound (P-2) and MP was the mol number of the terminal functional group of the imidized compound (P-2), the value of MC/(MAB+MP) was 0.85.

### Example 3 (Synthesis of Polyimide Resin 3 of Present Invention)

0.782 parts of DAPBAF (2,2-bis(3-amino-4-hydroxyphenyl)hexafluoropropane), manufactured by Wakayama Seika Kogyo Co., Ltd., molecular weight: 366.26 g/mol.), 11.784 parts of PRIAMINE1075 (manufactured by Croda Japan KK, molecular weight: 534.38 g/mol.), 5.723 parts of BAFL (9,9-bis(aminophenyl)fluorene, manufactured by JFE Chemical Corporation molecular weight: 348.16 g/mol), and 68.238 parts of anisole were added into a reactor with a total volume of 300 ml having a thermometer, a reflux cooler, a Dean-Stark apparatus, a powder inlet port, a nitrogen introduction device, and a stirrer and heated to 70° C. Next 12.409 parts of ODPA (oxydiphthalic anhydride, manufactured by Manac Incorporated, molecular weight: 310.22 g/mol.), 0.810 parts of triethylamine, and 14.987 parts of toluene were added. While the water generated by the cyclization of the amic acid was removed by azeotropy with toluene, the reaction was carried out at 130° C. for 8 hours to obtain the imidized compound (P-3) (phenolic OH equivalent, 6,851 g/eq., molecular weight: 91,100) solution. Then 0.992 parts of methacrylic acid chloride (manufactured by Tokyo Chemical Industry Co., Ltd., molecular weight: 104.53 g/mol) and 0.088 parts of BHT (2,6-di-tert-butyl-p-cresol) as the polymerization inhibitor were added. After the reaction was carried out at 130° C. for 4 hours, the remaining triethylamine and toluene were continuously removed at 10° C. to obtain the polyimide resin 3 solution. The molar ratio of the diamine component (component (a1), component (a2) and component (a3)) to the acid anhydride component (component (B)) used in Example 3 was 1.01 (the molar ratio is “the number of mol of the diamine component/the number of mol of the acid anhydride component”). When MC was the mole number of the component (C) having the functional group that can react with the phenolic hydroxy group and the ethylenically unsaturated double bond group, MAB was the mol number of the phenolic hydroxy group of the imidized compound (P-3) and MP was the mol number of the terminal functional group of the imidized compound (P-3), the value of MC/(MAB+MP) was 0.85.

### Example 4 (Synthesis of Polyimide Resin 4 of Present Invention)

0.552 parts of BAP (2,2-bis(3-amino-4-hydroxyphenyl) propane), manufactured by Tokyo Chemical Industry Co., Ltd., molecular weight: 258.32 g/mol.), 11.784 parts of PRIAINE1075 (manufactured by Croda Japan KK, molecular weight: 534.38 g/mol.), 5.723 parts of BAFL (9,9-bis(aminophenyl)fluorene, manufactured by JFE Chemical Corporation molecular weight: 348.16 g/mol), and 67.726 parts of anisole were added into a reactor with a total volume of 300 ml having a thermometer, a reflux cooler, a Dean-Stark apparatus, a powder inlet port, a nitrogen introduction device, and a stirrer and heated to 70° C. Next 12.409 parts of ODPA (oxydiphthalic anhydride, manufactured by Manac Incorporated, molecular weight: 310.22 g/mol.), 0.810 parts of triethylamine, and 14.950 parts of toluene were added. While the water generated by the cyclization of the amic acid was removed by azeotropy with toluene, the reaction was carried out at 130° C. for 8 hours to obtain the imidized compound (P-4) (phenolic OH equivalent, 6,797 g/eq., molecular weight: 78,300) solution. Then 0.446 parts of KarenzMOI (manufactured by Showa Denko K.K., molecular weight: 155.15 g/mol) and 0.087 parts of BHT (2,6-di-tert-butyl-p-cresol) as the polymerization inhibitor were added. After the reaction was carried out at 130° C. for 4 hours, the remaining triethylamine and toluene were continuously removed at 130° C. to obtain the polyimide resin 4 solution. The molar ratio of the diamine component (component (a1), component (a2) and component (a3)) to the acid anhydride component (component (B)) used in Example 4 was 1.01 (the molar ratio is “the number of mol of the diamine component/the number of mol of the acid anhydride component”). When MC was the mole number of the component (C) having the functional group that can react with the phenolic hydroxy group and the ethylenically unsaturated double bond group, MAB was the mol number of the phenolic hydroxy group of the imidized compound (P-4) and MP was the mol number of the terminal functional group of the imidized compound (P-4), the value of MC/(MAB+MP) was 0.85.

### Example 5 (Synthesis of Polyimide Resin 5 of Present Invention)

0.782 parts of DAPBAF (2,2-bis(3-amino-4-hydroxyphenyl)hexafluoropropane), manufactured by Wakayama Seika Kogyo Co., Ltd., molecular weight: 366.26 g/mol.), 11.784 parts of PRIAMINE1075 (manufactured by Croda Japan KK, molecular weight: 534.38 g/mol.), 4.801 parts of APPN (1,3-bis(3-aminophenoxy)benzene, manufactured by JFE Chemical Corporation molecular weight: 292.34 g/mol), and 66.190 parts of anisole were added into a reactor with a total volume of 300 ml having a thermometer, a reflux cooler, a Dean-Stark apparatus, a powder inlet port, a nitrogen introduction device, and a stirrer and heated to 70° C. Next 12.409 parts of ODPA (oxydiphthalic anhydride, manufactured by Manac Incorporated, molecular weight: 310.22 g/mol.), 0.810 parts of triethylamine, and 14.950 parts of toluene were added. While the water generated by the cyclization of the amic acid was removed by azeotropy with toluene, the reaction was carried out at 130° C. for 8 hours to obtain the imidized compound (P-5) (phenolic OH equivalent, 6,635 g/eq., molecular weight: 97,300) solution. Then 0.663 parts of KarenzMOI (manufactured by Showa Denko K.K., molecular weight: 155.15 g/mol) and 0.085 parts of BHT (2,6-di-tert-butyl-p-cresol) as the polymerization inhibitor were added. After the reaction was carried out at 130° C. for 4 hours, the remaining triethylamine and toluene were continuously removed at 130° C. to obtain the polyimide resin 5 solution. The molar ratio of the diamine component (component (a1), component (a2) and component (a3)) to the acid anhydride component (component (B)) used in Example 5 was 1.01 (the molar ratio is “the number of mol of the diamine component/the number of mol of the acid anhydride component”). When MC was the mole number of the component (C) having the functional group that can react with the phenolic hydroxy group and the ethylenically unsaturated double bond group, MAB was the mol number of the phenolic hydroxy group of the imidized compound (P-5) and MP was the mol number of the terminal functional group of the imidized compound (P-5), the value of MC/(MAB+MP) was 0.85.

### Comparative Example 1 (Synthesis of Polyimide Resin for Comparison 1)

0.782 parts of DAPBAF (2,2-bis(3-amino-4-hydroxyphenyl)hexafluoropropane), manufactured by Wakayama Seika Kogyo Co., Ltd., molecular weight: 366.26 g/mol.), 11.784 parts of PRIAMINE1075 (manufactured by Croda Japan KK, molecular weight: 534.38 g/mol.), 5.723 parts of BAFL (9,9-bis(aminophenyl)fluorene, manufactured by JFE Chemical Corporation molecular weight: 348.16 g/mol), and 68.238 parts of anisole were added into a reactor with a total volume of 300 ml having a thermometer, a reflux cooler, a Dean-Stark apparatus, a powder inlet port, a nitrogen introduction device, and a stirrer and heated to 70° C. Next 12.409 parts of ODPA (oxydiphthalic anhydride, manufactured by Manac Incorporated, molecular weight: 310.22 g/mol.), 0.810 parts of triethylamine, and 14.987 parts of toluene were added. While the water generated by the cyclization of the amic acid was removed by azeotropy with toluene, the reaction was carried out at 130° C. for 8 hours to obtain the polyimide resin for comparison 1 (phenolic OH equivalent, 6,851 g/eq., molecular weight:101,200) solution. The molar ratio of the diamine component (component (a1), component (a2) and component (a3)) to the acid anhydride component (component (B)) used in Comparative Example 1 was 1.01 (the molar ratio is “the number of mol of the diamine component/the number of mol of the acid anhydride component”).

### Comparative Example 2 (Synthesis of Polyimide Resin for Comparison 2)

12.441 parts of PRIAMINE1075 (manufactured by Croda Japan KK, molecular weight: 534.38 g/mol.), 6.042 parts of BAFL (9,9-bis(aminophenyl)fluorene, manufactured by JFE Chemical Corporation molecular weight: 348.16 g/mol), and 68.671 parts of anisole were added into a reactor with a total volume of 300 ml having a thermometer, a reflux cooler, a Dean-Stark apparatus, a powder inlet port, a nitrogen introduction device, and a stirrer and heated to 70° C. Next 12.409 parts of ODPA (oxydiphthalic anhydride, manufactured by Manac Incorporated, molecular weight: 310.22 g/mol.), 0.810 parts of triethylamine, and 15.019 parts of toluene were added. While the water generated by the cyclization of the amic acid was removed by azeotropy with toluene, the reaction was carried out at 130° C. for 8 hours. Then the remaining triethylamine and toluene were continuously removed at 130° C. to obtain the polyimide resin for comparison 2 (molecular weight:110,900) solution. The molar ratio of the diamine component (component (a1), component (a2) and component (a3)) to the acid anhydride component (component (B)) used in Comparative Example 2 was 1.01 (the molar ratio is “the number of mol of the diamine component/the number of mol of the acid anhydride component”).

### Comparative Example 3 (Synthesis of Polyimide Resin for Comparison 3)

0.799 parts of DAPBAF (2,2-bis(3-amino-4-hydroxyphenyl)hexafluoropropane), manufactured by Wakayama Seika Kogyo Co., Ltd., molecular weight: 366.26 g/mol.), 20.620 parts of PRIAMINE1075 (manufactured by Croda Japan KK, molecular weight: 534.38 g/mol.), and 75.196 parts of anisole were added into a reactor with a total volume of 300 ml having a thermometer, a reflux cooler, a Dean-Stark apparatus, a powder inlet port, a nitrogen introduction device, and a stirrer and heated to 70° C. Next 12.409 parts of ODPA (oxydiphthalic anhydride, manufactured by Manac Incorporated, molecular weight: 310.22 g/mol.), 0.810 parts of triethylamine, and 15.492 parts of toluene were added. While the water generated by the cyclization of the amic acid was removed by azeotropy with toluene, the reaction was carried out at 130° C. for 8 hours to obtain the imidized compound (P-6) (phenolic OH equivalent, 4,374 g/eq., molecular weight: 80,000) solution. Then 0.677 parts of KarenzMOI (manufactured by Showa Denko K.K., molecular weight: 155.15 g/mol) and 0.097 parts of BHT (2,6-di-tert-butyl-p-cresol) as the polymerization inhibitor were added. After the reaction was carried out at 130° C. for 4 hours, the remaining triethylamine and toluene were continuously removed at 130° C. to obtain the polyimide resin for comparison 3 solution. The molar ratio of the diamine component (component (a1), component (a2) and component (a3)) to the acid anhydride component (component (B)) used in Comparative Example 3 was 1.01 (the molar ratio is “the number of mol of the diamine component/the number of mol of the acid anhydride component”). When MC was the mole number of the component (C) having the functional group that can react with the phenolic hydroxy group and the ethylenically unsaturated double bond group, MAB was the mol number of the phenolic hydroxy group of the imidized compound (P-6) and MP was the mol number of the terminal functional group of the imidized compound (P-6), the value of MC/(MAB+MP) was 0.85.

### Example 6 to 14, Comparative Example 4 to 6

### (Preparation of Resin Composition of Present Invention and for Comparison)

After each component was blended in accordance with the amounts for blending (the unit was “part”, the number of parts of the polyimide resin and the maleimide resin were the number of parts in terms of solid content without the solvent) shown in Table 1, the resin compositions of the present invention and the resin compositions for comparison were prepared by adding anisole the amount of which satisfied that the concentration of the solid component was 20% by mass and mixing homogenously.

Note that each component shown in Table 1 was as follows.

### <Polyimide Resin>

The polyimide resins 1 to 5; the polyimide resin of the present invention obtained in Examples 1 to 5

The polyimide resins for comparison 1 to 3; the polyimide resin for comparison obtained in Comparative Examples 1 to 3

### <Thermosetting Resin>

MIR-3000-70MT; the maleimide resin, manufactured by Nippon Kayaku Co., Ltd.
XD-1000; the epoxy resin, manufactured by Nippon Kayaku Co., Ltd.
ZXR-1889H; the epoxyacrylate resin, manufactured by Nippon Kayaku Co., Ltd.

### <Curing Agent>

DCP; dicumylperoxide, manufactured by KAYAKU NOURYON CORPORATION

### <Additive>

KR-513; the silane coupling agent, manufactured by Shin-Etsu Chemical Co., Ltd.
TT-LX; The lubricating oil additive; manufactured by Johoku Chemical Co., Ltd.

By using each resin composition obtained in Examples 6 to 14 and Comparative Examples 4 to 6 adhesion strength to the copper foil, heat property and dielectric property (the dielectric constant and the dielectric loss tangent) of the cured products of the resin composition were evaluated according to the following methods.

### (Evaluation of Adhesion Strength)

The resin compositions obtained in Examples and Comparative Examples were coated on the rough surface of Non-Roughened Ultra Very Low Profile ED Copper Foil CF-T9DA-SV manufactured by FUKUDA METAL FOIL & POWDER Co., Ltd. (hereinafter described as “T9DA”) by using the automatic applicator respectively and dried by heating at 120° C. for 10 minutes. The thickness of the film after drying was 30 μm. On the film on the copper foil obtained above, PPE prepreg (Meteorwave4000, manufactured by AGC nelco Inc.) was superimposed and vacuum-pressed with a pressure of 3 Mpa at 200° C. for 60 minutes. The test piece obtained was cut out by the width of 10 mm and the 90° peeling strength between the copper foil and the PPE prepreg was measured (the peeling speed was 50 mm/min) by using Auto Graph AGS-X-500N (manufactured by Shimazu Corporation) to evaluate the adhesion strength to PPE prepreg. The results were shown in Table 1.

### (Evaluation of Thermal Property)

The test piece made by the same method as the method in “Evaluation of Adhesion Strength” described above was floated in the solder bath heated at 288° C. by using POT-200C (manufactured by TAIYO ELECTRIC IND. CO., LTD.). Thermal property was evaluated by the time until the blister occurred. The results were shown in Table 1. The meanings of the signs in Table were described below.
◯ (good) . . . The time until the blister occurred after the test piece was floated in the solder bath was not less than 600 seconds.
x (poor) . . . The blister occurred in less than 600 seconds after the test piece was floated in the solder bath.

### (Evaluation of Dielectric Constant and Dielectric Loss Tangent)

The films having a thickness of 100 μm after drying were formed on the rough surface of T9DA respectively by the same method as the method in “Evaluation of Adhesion Strength” described above, provided that the coating thickness of the automatic applicator was changed, and the formed film was cured by heating at 200° C. for 60 minutes. The copper foil was removed by etching with iron (III) chloride solution having a liquid specific gravity of 45 baume degree. After washing with ion-exchanged water, the film-like cured products were obtained respectively by drying at 105° C. for 10 minutes. As for the film-like cured products, dielectric constant and dielectric loss tangent at 10 Ghz were measured by using Network Analyzer 8719ET (manufactured by Agilent Technologies Japan, Ltd.) and by the cavity resonance method. The results were shown in Table 1.

TABLE 1

| | Example | | | | | | | | | Comparative Example | | |
|---|---|---|---|---|---|---|---|---|---|---|---|---|
| | 6 | 7 | 8 | 9 | 10 | 11 | 12 | 13 | 14 | 4 | 5 | 6 |
| Polyimide resin 1 | 80 | | | | | 80 | 80 | 80 | 80 | | | |
| Polyimide resin 2 | | 80 | | | | | | | | | | |
| Polyimide resin 3 | | | 80 | | | | | | | | | |
| Polyimide resin 4 | | | | 80 | | | | | | | | |
| Polyimide resin 5 | | | | | 80 | | | | | | | |
| Polyimide resin for | | | | | | | | | | 80 | | |
| comparative example 1 | | | | | | | | | | | | |
| Polyimide resin for | | | | | | | | | | | 80 | |
| comparative example 2 | | | | | | | | | | | | |
| Polyimide resin for | | | | | | | | | | | | 80 |
| comparative example 3 | | | | | | | | | | | | |
| MIR-3000-70MT | 20 | 20 | 20 | 20 | 20 | 20 | 20 | 20 | 20 | 20 | 20 | 20 |
| XD-1000 | | | | | | 4 | | | | | | |
| ZXR-1889H | | | | | | | 4 | | | | | |
| DCP | 1.5 | 1.5 | 1.5 | 1.5 | 1.5 | 1.5 | 1.5 | 1.5 | 1.5 | 1.5 | 1.5 | 1.5 |
| KR-513 | | | | | | | | 1 | | | | |
| TT-LX | | | | | | | | | 1 | | | |
| Adhesion strength | 6.2 | 6.5 | 6.2 | 6.0 | 6.3 | 6.3 | 6.4 | 6.3 | 6.2 | 4.4 | 3.4 | 4.3 |
| [N/cm] | | | | | | | | | | | | |
| Heat resistance test | ∘ | ∘ | ∘ | ∘ | ∘ | ∘ | ∘ | ∘ | ∘ | x | ∘ | x |
| Dielectric constant | 2.6 | 2.7 | 2.6 | 2.6 | 2.6 | 2.7 | 2.7 | 2.6 | 2.6 | 2.6 | 2.6 | 2.6 |
| Dielectric loss tangent | 0.0018 | 0.0020 | 0.0017 | 0.0020 | 0.0020 | 0.0023 | 0.0023 | 0.0019 | 0.0019 | 0.0019 | 0.0018 | 0.0020 |

From the results shown in Table 1, the resin composition of the present invention was excellent in all of adhesion strength, heat resistance and dielectric constant, but the resin composition in Comparative Examples, in contrast, were inferior in adhesion and heat resistance.

### INDUSTRIAL APPLICABILITY

By using the polyimide resin of the present invention having a specific structure, the printed wiring board and the like excellent in the characteristics such as heat resistance, mechanical property, low dielectric property, adhesion can be provided.

1. A polyimide resin that is a reaction product of
an imidized compound (P) of a polyamic acid resin,
the polyamic acid resin being a copolymer of
amino compounds (A) containing an aminophenol compound (a1) having at least two amino groups per a molecule, an aliphatic diamino compound (a2) having 6-36 carbon atoms and an aromatic diamino compound (a3) having no phenolic hydroxy group and
a tetrabasic acid dianhydride (B),
with a compound (C) having
a functional group that can react with a phenolic hydroxy group and
an ethylenically unsaturated double bond group

2. The polyimide resin according to claim 1, wherein the aminophenol compound (a1) comprises a compound represented by a following formula (1): 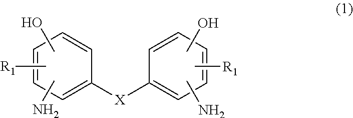
wherein in formula (1), R₁ is a hydrogen atom, a methyl group or an ethyl group, and X is C(CH₃)₂, C(CF₃)₂, SO₂, an oxygen atom, a direct bond or a bivalent linking group represented by a following formula (2):

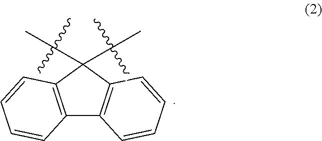 [SMILES: *C1(*)c2ccccc2-c2ccccc21]

3. The polyimide resin according to claim 1, wherein the tetrabasic acid dianhydride (B) comprises at least one selected from a group consisting of compounds represented by following formulas (3) to (7): 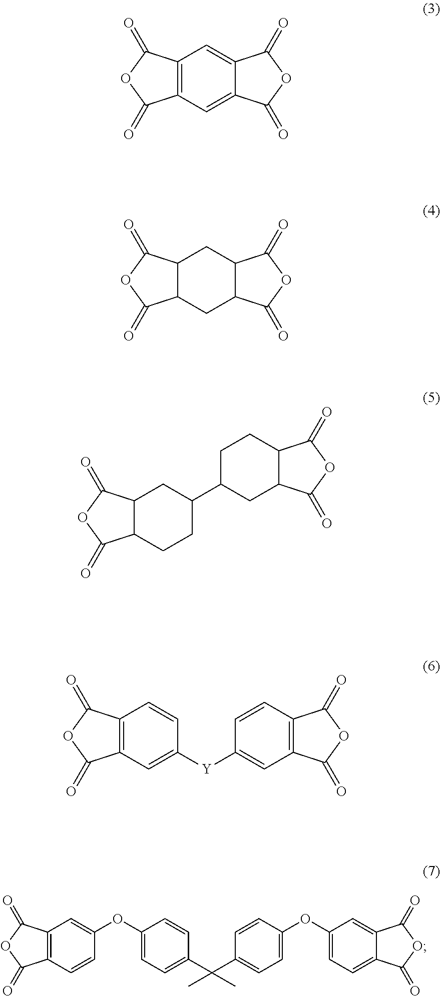
wherein in formula (6), Y is C(CF₃)₂, SO₂, CO, an oxygen atom, a direct bond or a bivalent linking group represented by following formula (2):

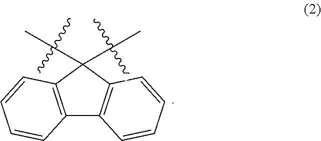 [SMILES: *C1(*)c2ccccc2-c2ccccc21]

4. The polyimide resin according to claim 1, wherein the functional group, of the compound (C) that can react with the phenolic hydroxy group, is an isocyanate group or a carboxylic acid chloride group.

5. The polyimide resin according to claim 1, wherein the aromatic diamino compound (a3) comprises at least one selected from a group consisting of compounds represented by following formulas (8) to (11): 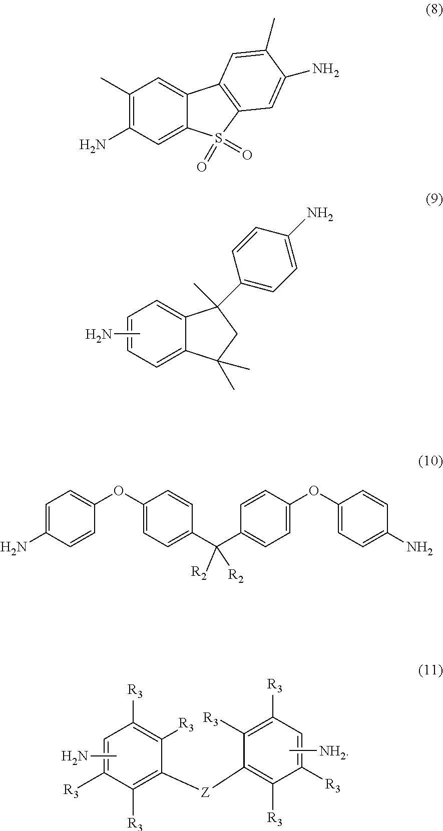
wherein in formula (10), R₂ is each independently a methyl group or a trifluoromethyl group, in formula (11), Z is CH(CH₃), SO₂, CH₂, O—C₆H₄—O, an oxygen atom, a direct bond or a bivalent linking group represented by a following formula (2):

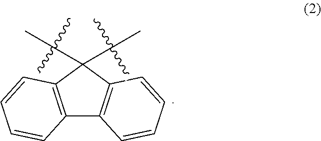 [SMILES: *C1(*)c2ccccc2-c2ccccc21]

6. A resin composition comprising the polyimide resin according to claim 1 and a thermosetting resin.

7. The resin composition according to claim 6, further comprising a curing agent.

8. The resin composition according to claim 6, further comprising a silane coupling agent having an acrylic group.

9. A cured product of the resin composition according to claim 6.

10. An article provided with the cured product according to claim 9.
